(19) United States
(12) Patent Application Publication
(10) Pub. No.: US 2007/0147088 A1
(43) Pub. Date: Jun. 28, 2007

(54) Backlight module with dual light guide plates and liquid crystal display with same

(75) Inventors: Ko-Wei Chien, Miao-Li (TW); Yu-Ju Hsu, Miao-Li (TW); Hsin-Ming Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/645,414

(22) Filed: Dec. 26, 2006

(30) Foreign Application Priority Data
Dec. 23, 2005 (TW) 94146355

(51) Int. Cl. F21V 7/04

(52) U.S. Cl. 362/616

(57) ABSTRACT

An exemplary backlight module (11) includes a first light guide plate (15), and a second light guide plate (17). The first light guide plate includes a first bottom surface (156), and plural reflective micro-structures (158) formed at the first bottom surface. The second light guide plate is located adjacent the first bottom surface of the first light guide plate. The second light guide plate includes a second bottom surface (176), and plural diffusing micro-structures (178) formed at the second bottom surface.

### FIELD OF THE INVENTION

The present invention relates to a backlight module that includes dual light guide plates for providing desired display modes, and a liquid crystal display including the backlight module.

### GENERAL BACKGROUND

Liquid crystal displays are commonly used as display devices for compact electronic apparatuses, because they not only provide good quality images but are also very thin. Because liquid crystal in a liquid crystal display does not emit any light itself, the liquid crystal requires a light source to clearly and sharply display text and images. Therefore, liquid crystal displays typically require a backlight module.

Referring to FIG. 6, a typical liquid crystal display 6 includes a liquid crystal panel 60, and a backlight module 62 located adjacent the liquid crystal panel 60 for providing a planar light source for the liquid crystal panel 60. The liquid crystal panel 60 includes a transparent first substrate 602, a transparent second substrate 604, and a liquid crystal layer 606 sandwiched between the first substrate 602 and the second substrate 604. The liquid crystal layer 606 includes a plurality of pixels 608 arrayed in a matrix, which pixels 608 are controlled to be on or off by a driving circuit (not shown) of the liquid crystal display 6.

Light beams emitting from the backlight module 62 reach the liquid crystal panel 60 and strike the second substrate 604. Some light beams are reflected back to the backlight module 62 when an incident angle thereof is equal to or greater than a critical angle θ₃ to the second substrate 604, and reach the liquid crystal panel 60 again after being reflected by the backlight module 62. Light beams not reflected by the second substrate 604 are refracted by the second substrate 604, and reach the liquid crystal layer 606.

The liquid crystal display 6 can operate in a first display mode that provides narrow viewing angles. In the first display mode, the pixels 608 of even columns or odd columns of the matrix are turned off, thus forming a plurality of spaced absorbing zones 609. The light beams striking the absorbing zones 609 are absorbed when an incident angle thereof is in a range from θ₁ to θ₂, wherein θ₁ is an angle of a light beam striking a right edge relative to a normal of a light guide plate (not labeled) of the backlight module 62, and θ₂ is an angle of a light bean striking a left edge relative to the normal of the light guide plate. That is, only light beams with a narrow incident angle can pass through the liquid crystal panel 60 and be viewed.

The liquid crystal display 6 can also operate in a second display mode that provides wide viewing angles. In the second display mode, the pixels 608 are all turned on by the driving circuit. Light beams entering the liquid crystal panel 60 are substantially all viewable.

With the above-described configuration, the display mode having the liquid crystal display 6 can be conveniently switched by controlling the pixels 608 to be on or off. However, when the liquid crystal display 6 works in the first display mode, a plurality of light beams are absorbed by the absorbing zones 609. This results in a degraded ratio of light utilization of the liquid crystal display 6.

What is needed, therefore, is a backlight module that can overcome the above-described deficiencies. What is also needed is a liquid crystal display including the backlight module.

### SUMMARY

In one preferred embodiment, a backlight module includes a first light guide plate, and a second light guide plate. The first light guide plate includes a first bottom surface, and a plurality of reflective micro-structures formed at the first bottom surface. The second light guide plate is located adjacent the first bottom surface of the first light guide plate. The second light guide plate includes a second bottom surface, and a plurality of diffusing micro-structures formed at the second bottom surface.

Other aspects, advantages and novel features will become more apparent from the following detailed description when taken in conjunction with the accompanying drawings;

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, side view of a liquid crystal display according to a first embodiment of the present invention, the liquid crystal display including a first light guide plate cooperating with a first light source, and a second light guide plate cooperating with a second light source.

FIG. 2 is a side view of some components of the liquid crystal display of FIG. 1, showing essential optical paths of the first light guide plate when the first light source is on and the second light source is not on.

FIG. 3 is an enlarged view of a circled portion III of FIG. 2.

FIG. 4 is a side view similar to that of FIG. 2, but showing essential optical paths of the first light guide plate and the second light guide plate when the first light source is not on and the second light source is on.

FIG. 5 is an exploded, side view of a liquid crystal display according to a second embodiment of the present invention.

FIG. 6 is an exploded, side view of a conventional liquid crystal display, showing essential optical paths thereof.

### DETAILED DESCRIPTION OF PREFERRED EMBODIMENTS

Reference will now be made to the drawings to describe preferred embodiments of the present invention in detail.

Referring to FIG. 1, a liquid crystal display 1 according to a first embodiment of the present invention is shown. The liquid crystal display 1 includes a liquid crystal panel 10, and a backlight module 11 located adjacent the liquid crystal panel 10.

The liquid crystal panel 10 includes a first substrate 102, a second substrate 104 opposite to the first substrate 102, and a liquid crystal layer 106 sandwiched between the first substrate 102 and the second substrate 104. The first substrate 102 and the second substrate 104 are both transparent, and are generally made from glass or quartz.

The backlight module 11 includes a diffusing film 12, a first brightness enhancement film (BEF) 13, a second BEF 14, a first light guide plate 15, a first light source 16, a second light guide plate 17, a second light source 18, and a reflective film 19. The diffusing film 12, the first BEF 13, the second BEF 14, the first light guide plate 15, the second light guide plate 17, and the reflective film 19 are arranged in that order from top to bottom. The diffusing film 12 is located adjacent the second substrate 104 of the liquid crystal panel 10. The first light source 16 is located adjacent a first light incident surface 152 of the first light guide plate 15. The second light source 18 is located adjacent a second light incident surface 172 of the second light guide plate 17.

The first light guide plate 15 is generally wedge-shaped. The first light guide plate 15 further includes a first top surface 154 perpendicularly connected with the first light incident surface 152, and a first bottom surface 156 slantways connected with the first light incident surface 152 and is opposite to the first top surface 154. That is, the first top surface 154 is adjacent the first light incident surface 152, and the first bottom surface 156 is also adjacent the first light incident surface 152 and is opposite to the first top surface 154. The second BEF 14 is disposed adjacent the first top surface 154 of the first light guide plate 15. The first light source 16 includes a first illuminator 162, and a first reflector 164 cooperating with the first light incident surface 152 to generally surround the first illuminator 162. In the illustrated embodiment, the first illuminator 162 is a cold cathode fluorescent lamp (CCFL).

The first light guide plate 15 further includes a plurality of reflective micro-structures 158 formed on the first bottom surface 156 thereof. The reflective micro-structures 158 are generally micro-sized V-shaped prism structures, and progressively increase in density with increasing distance away from the first light incident surface 152. The reflective micro-structures 158 have substantially the same orientation. That is, a face of each prism nearest to the first light incident surface 152 is approximately parallel to the first light incident surface 152, and a face of each prism farthest from the first light incident surface 152 is slanted relative to the first light incident surface 152. The slant is such that a bottom of the farthest face is nearest to the first light incident surface 152, and a top of the farthest face is farthest from the first light incident surface 152. The first light guide plate 15 having the reflective micro-structures 158 can be made from polycarbonate (PC) or polymethyl methacrylate (PMMA). The first light guide plate 15 having the reflective micro-structures 158 can be manufactured by an injection molding method, or can be formed by a hot embossing method after a preform of the first light guide plate 15 is manufactured.

The second light guide plate 17 is generally wedge-shaped. The second light guide plate 17 further includes a second top surface 174 slantways connected with the second light incident surface 172, and a second bottom surface 176 perpendicularly connected with the second light incident surface 172. That is, the second top surface 174 is adjacent the second light incident surface 172, and the second bottom surface 176 is also adjacent the second light incident surface 172 and is opposite to the second top surface 174. The second top surface 174 of the second light guide plate 17 is adjacent and parallel to the first bottom surface 156 of the first light guide plate 15. The second bottom surface 176 of the second light guide plate 17 is substantially parallel to the first top surface 154 of the first light guide plate 15. The reflective film 19 is disposed adjacent the second bottom surface 176 of the second light guide plate 17. The second light source 18 includes a second illuminator 182, and a second reflector 184 cooperating with the second light incident surface 172 to generally surround the second illuminator 182. In the illustrated embodiment, the second illuminator 182 is a CCFL.

The second light guide plate 17 further includes a plurality of diffusing micro-structures 178 formed on the second bottom surface 176 thereof. In the illustrated embodiment, the diffusing micro-structures 178 generally include micro-sized diffusing dots located inwardly extending from the second bottom surface 176. The diffusing micro-structures 178 progressively increase in density with increasing distance away from the second light incident surface 172. The second light guide plate 17 can be made from PC or PMMA.

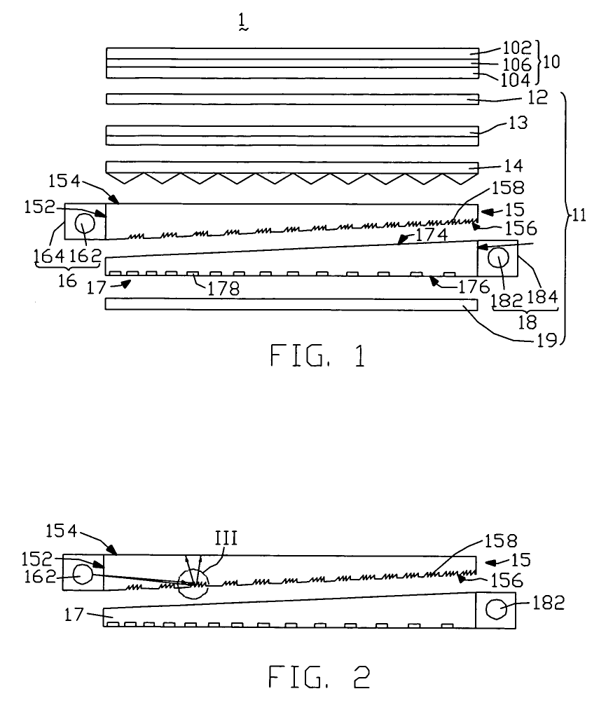

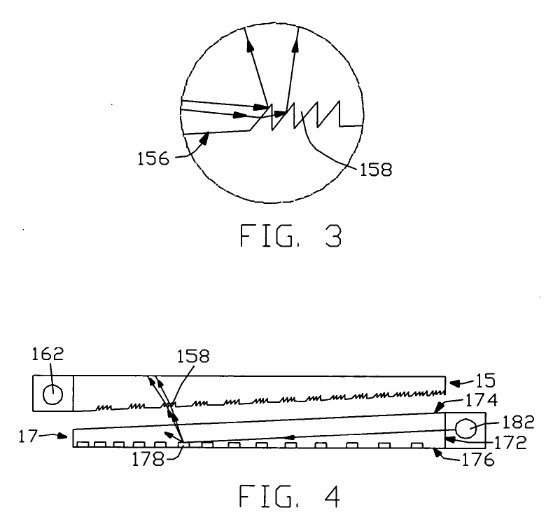

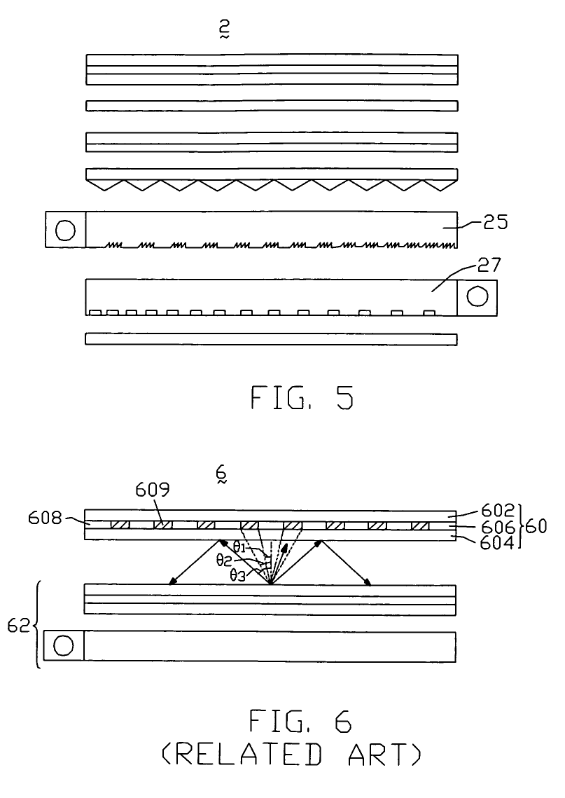

Referring also to FIG. 2 and FIG. 3, when the first illuminator 162 is on and the second illuminator 182 is off, light beams emitted from the first illuminator 162 enter the first light guide plate 15 through the first light incident surface 152. Some light beams directly propagate toward the first top surface 154, and are emitted from the first light guide plate 15 after being refracted by the first top surface 154. Other light beams propagate toward the first bottom surface 156 and strike the reflective micro-structures 158. Some of the light beams striking the reflective micro-structures 158 are totally reflected when an incident angle thereof is equal to or greater than a critical angle of the reflective micro-structures 158, and further propagate toward the first top surface 154. The remaining light beams striking the reflective micro-structures 158 are refracted and enter an adjacent reflective micro-structure 158, when the incident angle thereof is less than the critical angle of the reflective micro-structures 158, until they are all, or substantially all, reflected and further propagate toward the first top surface 154.

With the above-described configuration, an angle of divergence of the light beams striking the reflective micro-structures 158 is narrow. Therefore, the liquid crystal display 1 can obtain a first display mode having narrow viewing angles. What has been confirmed by experiments is that when the liquid crystal display 1 works in the first display mode, a horizontal viewing angle thereof is in the range of ±30 degrees, and a vertical viewing angle thereof is in the range of ±35 degrees. Further, the travel distance of the light beams striking the reflective micro-structures 158 in the first light guide plate 15 is short, and loss of light energy is minimized, which enables the backlight module 11 to provide a high ratio of light utilization.

Referring also to FIG. 4, when-the first illuminator 162 is off and the second illuminator 182 is on, light beams emitted from the second illuminator 182 enter the second light guide plate 17 through the second light incident surface 172. Some light beams directly propagate toward the second top surface 174, and are emitted from the second light guide plate 17 after being refracted by the second top surface 174. Other light beams propagate toward the second bottom surface 176 and strike the diffusing micro-structures 178. The light beams striking the diffusing micro-structures 178 are diffused in all directions. Some diffused light beams emit from the second light guide plate 17 through the second bottom surface. 176, and propagate toward the reflective film 19 adjacent the second bottom surface 176. Those light beams are further reflected back into the second light guide plate 17 by the reflective film, and finally propagate toward the first light guide plate 15 with the other diffused light beams. The light beams emitted from the second light guide plate 17 enter the first light guide plate 15 and are further diffused when they strike the reflective micro-structures 158.

With the above-described configuration, an angle of divergence of the light beams of the backlight module 11 is broad. Therefore, the liquid crystal display 1 can obtain a second display mode having wide viewing angles. What has been also confirmed by experiments is that when the liquid crystal display 1 works in the second display mode, the horizontal viewing angle thereof is in the range of ±70 degrees, and the vertical viewing angle thereof is in the range of ±65 degrees.

When the first illuminator 162 and the second illuminator 182 are both on, light beams emitted from the first illuminator 162 and the second illuminator 182 are superimposed. This greatly improves brightness of the liquid crystal display 1. That is, the liquid crystal display 1 can obtain a third display mode having high brightness.

Referring to FIG. 5, a liquid crystal display 2 of a second embodiment of the present invention is similar to the liquid crystal display 1. However, a first light guide plate 25 and a second light guide plate 27 of the liquid crystal display 2 are both substantially flat. The liquid crystal display 2 can achieve advantages similar to those described above in relation to the liquid crystal display 1.

Further or alternative embodiments may include the following. In one example, the first illuminator 162 and the second illuminator 182 can also include one or more light emitting diodes (LEDs).

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A backlight module comprising:
a first light guide plate comprising:
a first bottom surface; and
a plurality of reflective micro-structures formed at the first bottom surface; and
a second light guide plate adjacent the first bottom surface of the first light guide plate, the second light guide plate comprising:
a second bottom surface; and
a plurality of diffusing micro-structures formed at the second bottom surface.

2. The backlight module as claimed in claim 1, wherein the first light guide plate further comprises a first light incident surface adjacent the first bottom surface.

3. The backlight module as claimed in claim 2, further comprising a first illuminator located adjacent the first light incident surface.

4. The backlight module as claimed in claim 1, wherein the reflective micro-structures are micro-sized, V-shaped prism structures.

5. The backlight module as claimed in claim 2, wherein the reflective micro-structures progressively increase in density with increasing distance away from the first light incident surface.

6. The backlight module as claimed in claim 2, wherein the reflective micro-structures comprise substantially the same orientation, a face of each micro-structures farthest from the first light incident surface being slanted relative to the first light incident surface.

7. The backlight module as claimed in claim 1, wherein the reflective micro-structures are injection molded portions of a main body of the first light guide plate, or are hot embossed portions of a main body of the first light guide plate.

8. The backlight module as claimed in claim 3, wherein the second light guide plate further comprises a second light incident surface adjacent the second bottom surface.

9. The backlight module as claimed in claim 8, further comprising a second illuminator located adjacent the second light incident surface.

10. The backlight module as claimed in claim 1, wherein the diffusing micro-structures are a plurality of diffusing dots.

11. The backlight module as claimed in claim 10, wherein the diffusing micro-structures inwardly extending from the second bottom surface.

12. The backlight module as claimed in claim 8, wherein the diffusing micro-structures progressively increase in density with increasing distance away from the second light incident surface.

13. The backlight module as claimed in claim 1, wherein the first light guide plate and the second light guide plate are wedge-shaped.

14. The backlight module as claimed in claim 13, wherein the first light guide plate further comprises a first top surface substantially parallel to the second bottom surface.

15. The backlight module as claimed in claim 14, wherein the second light guide plate further comprises a second top surface substantially parallel to the first bottom surface of the first light guide plate.

16. The backlight module as claimed in claim 1, wherein the first light guide plate and the second light guide plate are flat sheets each having a uniform thickness.

17. A liquid crystal display comprising:
a liquid crystal panel; and
a backlight module located adjacent the liquid crystal panel, the backlight module comprising:
a first light guide plate comprising:
a first bottom surface; and
a plurality of reflective micro-structures formed at the first bottom surface; and
a second light guide plate adjacent the first bottom surface of the first light guide plate, the second light guide plate comprising:
a second bottom surface; and
a plurality of diffusing micro-structures formed at the second bottom surface.

18. A backlight module comprising:
a first light guide plate defining opposite top and bottom surfaces;
a second light guide plate positioned on the first light guide plate and defining opposite top and bottom surfaces; wherein
the top surface of the first light guide plate defines a wedged configuration complementary with another wedged configuration defined by the bottom surface of the second light guide plate, and a plurality of diffusing micro-structures formed on the bottom surface of at least one of said first and second guide plates.
